(19) United States
(12) Patent Application Publication
(10) Pub. No.: US 2025/0278539 A1
(43) Pub. Date: Sep. 4, 2025

(54) MODEL CONSTRUCTION FOR SELECTING AQUIFERS FOR CARBON STORAGE

(71) Applicant: S&P Global Inc., New York, NY (US)

(72) Inventors: Mehran Pooladi-Darvish, Calgary (CA); Seyedhamed Tabatabaie, Calgary (CA); Hojjat Khani, Calgary (CA); Mohammad Tavallali, Calgary (CA); Camilo Rodriguez, Houston, TX (US)

(21) Appl. No.: 18/592,615

(22) Filed: Mar. 1, 2024

(51) Int. Cl. G06F 30/27; G06F 111/10

(52) U.S. Cl. CPC G06F 30/27; G06F 2111/10

(57) ABSTRACT

An aquifer management system is provided. The aquifer management system includes a computer system and a model manager. The model manager generates simulation data for simulation parameters for aquifers using a set of numerical simulation models with historical data for aquifer parameters for the aquifers as inputs to the set of numerical simulation models. The model manager generates auxiliary quantities for auxiliary parameters for the aquifers using a set of physics-based equations and the simulation data for a set of selected simulation parameters. The model manager creates a training dataset using the simulation data and the auxiliary quantities. The model manager trains a machine learning model using the training dataset to select a set of aquifers that meet a set of carbon storage requirements to store carbon dioxide.

### BACKGROUND INFORMATION

### 1. Field

The present disclosure relates generally to a method and system for selecting aquifers and more specifically to select aquifers with desired capacity and connectivity for storing carbon dioxide.

### 2. Background

Aquifers are underground layers for storing and transmitting groundwater. Aquifers usually include porous material such as sand, gravel, or permeable rock that form interconnected spaces to hold water. The geological formation of aquifers can store huge amounts of water and act as natural reservoirs to provide a source of water for wells and springs.

Further, aquifers can be used to store carbon dioxide to mitigate greenhouse gas emissions. In this case, compressed carbon dioxide can be injected into suitable aquifers, where various trapping techniques can be used to ensure secure storage of carbon dioxide within aquifers.

### SUMMARY

According to one illustrative embodiment, an aquifer management system is provided. The aquifer management system includes a computer system and a model manager. The model manager generates simulation data for simulation parameters for aquifers using a set of numerical simulation models with historical data for aquifer parameters for the aquifers as inputs to the set of numerical simulation models. The model manager generates auxiliary quantities for auxiliary parameters for the aquifers using a set of physics-based equations and the simulation data for a set of selected simulation parameters. The model manager creates a training dataset using the simulation data and the auxiliary quantities. The model manager trains a machine learning model using the training dataset to select a set of aquifers that meet a set of carbon storage requirements to store carbon dioxide.

According to another illustrative embodiment, a computer implemented method for training a machine learning model to select aquifers for carbon storage is provided. A number of processor units generate simulation data for simulation parameters for aquifers using a set of numerical simulation models with historical data for aquifer parameters for the aquifers as inputs to the set of numerical simulation models. The number of processor units generate auxiliary quantities for auxiliary parameters for the aquifers using a set of physics-based equations and the simulation data for a set of selected simulation parameters. The number of processor units create a training dataset using the simulation data and the auxiliary quantities. The number of processor units. The number of processor units train a machine learning model using the training dataset for selecting a set of aquifers that meet a set of carbon storage requirements to store carbon dioxide.

According to yet another illustrative embodiment, a computer implemented method for storing carbon dioxide is provided. A number of processor units receive input data for aquifer parameters for a number of candidate aquifers. The number of processor units send the input data to a machine learning model trained using a training dataset comprising combinations of data for the aquifer parameters, simulation parameters, and auxiliary parameters. The number of processor units receive results for candidate aquifers from the machine learning model in response to sending the input data to the machine learning model. The number of processor units identify a set of aquifers that meet a set of carbon storage requirements from the number of candidate aquifers based on the results received from the machine learning model.

According to yet another illustrative embodiment, a computer program product for training a machine learning model to select aquifers for carbon storage is provided. The computer program product includes a set of one or more computer-readable storage media and program instructions collectively stored in the set of one or more storage media; cause a number of processor units to generate simulation data for simulation parameters for aquifers using a set of numerical simulation models with historical data for aquifer parameters for the aquifers as inputs to the set of numerical simulation models; generate auxiliary quantities for auxiliary parameters for the aquifers using a set of physics-based equations and the simulation data for a set of selected simulation parameters create a training dataset using the simulation data and the auxiliary quantities; and train a machine learning model using the training dataset to select a number of the aquifers that meet a set of carbon storage requirements to store carbon dioxide.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of an aquifer management environment depicted in accordance with an illustrative embodiment;

FIG. 3 is a block diagram of an aquifer selection environment depicted in accordance with an illustrative embodiment;

FIG. 4 depicts a diagram illustrating a user interface in accordance with an illustrative embodiment;

FIG. 5 depicts a diagram illustrating a user interface in accordance with an illustrative embodiment;

FIG. 6 depicts a flowchart illustrating a process for training a machine learning model to select aquifers for carbon storage in accordance with an illustrative embodiment;

FIG. 7 depicts a flowchart illustrating a process for generating a training dataset in accordance with an illustrative embodiment;

FIG. 8 depicts a flowchart illustrating a process for identifying aquifers to store carbon dioxide in accordance with an illustrative embodiment;

FIG. 9 depicts a flowchart illustrating a process for identifying aquifers using the machine learning model in accordance with an illustrative embodiment;

FIG. 10 depicts a flowchart illustrating a process for generating output for selecting aquifers for carbon storage in accordance with an illustrative embodiment;

FIG. 11 depicts a flowchart illustrating a process for storing carbon dioxide in accordance with an illustrative embodiment;

FIG. 12 is a block diagram of a data processing system in accordance with an illustrative embodiment.

### DETAILED DESCRIPTION

The illustrative embodiments recognize and take into account a number of considerations. For example, the illustrative embodiments recognize and take into account that geological storage of carbon dioxide includes capture of carbon dioxide, transportation of carbon dioxide, and storage of carbon dioxide.

The illustrative embodiments also recognize and take into account that standards developed for geological storage of carbon dioxide suggests that storage sites are determined through workflow that start with screening of aquifer sites that begins with an assessment of high level information available for each aquifer site and followed by more detailed characterizations and analysis of the selected sites identified during the screening process.

The illustrative embodiments also recognize and take into account that current approaches to select aquifers for carbon storages have drawbacks. For example, current approaches include physics-based models that do not properly consider the complex physics of two-phase flow and solubility of the carbon dioxide in the formation brine and cannot accurately account for the interference among wells within an aquifer.

In another example, current approaches also include physics-based model that use numerical solution to address complex physics issues. However, those models require a large set of input data and therefore are time consuming and require huge amount of computing resources.

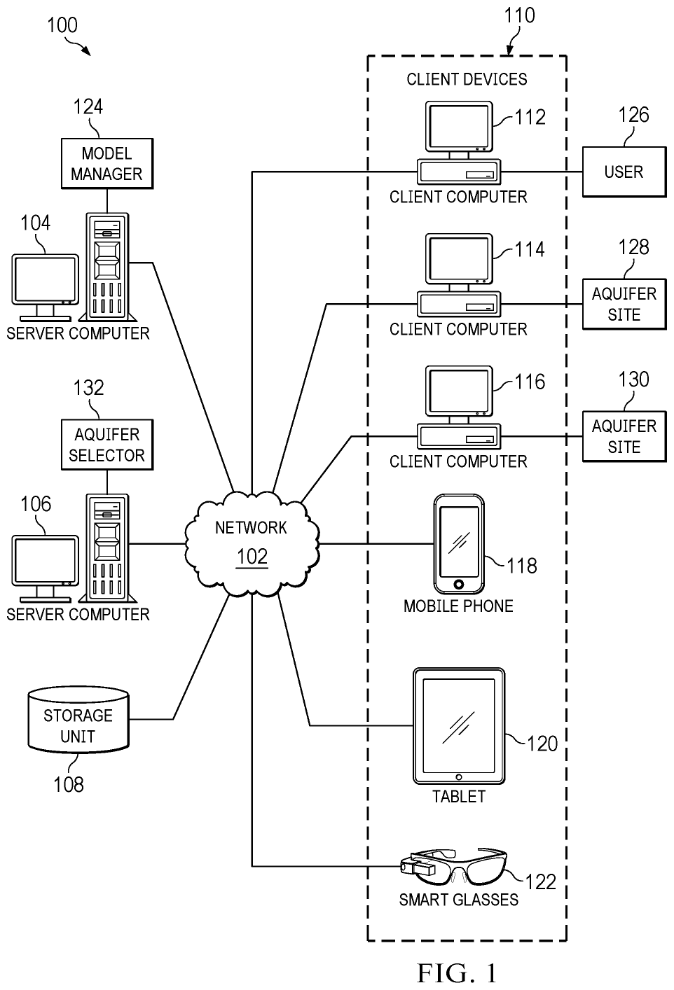

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information such as boot files, operating system images, and applications to client devices 110. Client devices 110 can be, for example, computers, workstations, or network computers. As depicted, client devices 110 includes client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example and not as an architectural limitation for the different illustrative embodiments.

In this illustrative example, one or more of client devices 110 can be configured for users and aquifer sites. For example, client computer 114 can include hardware or can be connected to at least one hardware sensors that detect various aquifer parameters for aquifer site 128. In a similar fashion, client computer 116 can detect various aquifer parameters for aquifer site 130. In this illustrative example, aquifer site 128 and aquifer site 130 are areas where aquifers can be located.

For example, client computer 114 and client computer 116 can detect aquifer parameters such as aquifer size, aquifer thickness, aquifer depth, a petrophysical property, a pressure condition, a temperature condition, a fluid property, a solubility condition, a two-phase flow property, a porosity, a fracturing condition, a permeability, or other parameters.

In this example, user 126 can interact with other devices in network data processing system 100 using one of devices in client devices 110, such as client computer 112.

In this illustrative example, values for aquifer parameters collected by client computer 114 and client computer 116 can be used by model manager 124 on server computer 104 for training a machine learning model to select aquifers for carbon storage.

In this illustrative example, aquifer selector 132 on server computer 106 can use the machine learning model trained by model manager 124 to select an aquifer that meets a set of carbon storage requirements for carbon storage. In this illustrative example, the set of carbon storage requirements can include capacity, injection rate, a rate of carbon storage, or any parameters that can be used for determining whether an aquifer is suitable for carbon storage.

For example, user 126 at client computer 112 can provide input data to aquifer selector 132 for selecting aquifer for carbon storage. Input data can be information related to aquifer parameters for a number of candidate aquifers. As a result, aquifer selector 132 uses the input data and the machine learning model trained by model manager 124 to select aquifers from the number of candidate aquifers for carbon storage.

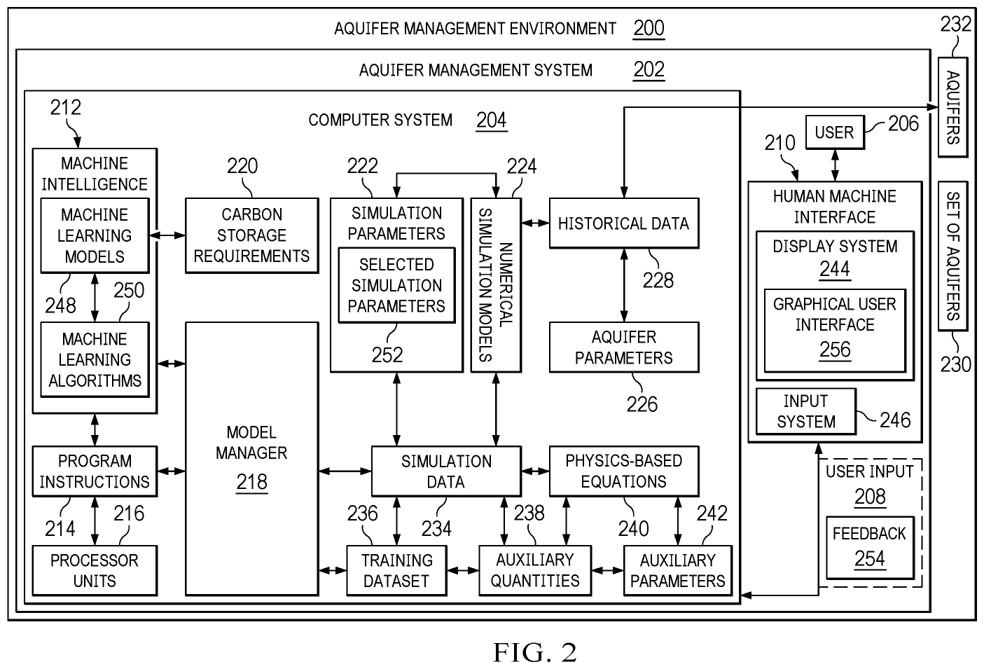

With reference now to FIG. 2, an illustration of a block diagram of an aquifer management environment is depicted in accordance with an illustrative embodiment. In this illustrative example, aquifer management environment 200 includes components that can be implemented in hardware such as the hardware shown in network data processing system 100 in FIG. 1.

In this illustrative example, aquifer management system 202 in aquifer management environment 200 uses information received from aquifers 232 to train machine learning models for selecting aquifers that meet carbon storage requirements for carbon storage.

In this illustrative example, aquifer management system 202 includes computer system 204 and model manager 218. Model manager 218 is located in computer system 204. Model manager 218 can be an example of model manager 124 in FIG. 1.

Model manager 218 can be implemented in software, hardware, firmware, or a combination thereof. When software is used, the operations performed by model manager 218 can be implemented in program instructions configured to run on hardware such as a processor unit. When firmware is used, the operations performed by model manager 218 can be implemented in program instructions and data and stored in persistent memory to run on a processor unit. When hardware is employed, the hardware can include circuits that operate to perform the operations in model manager 218.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

As used herein, when used with reference to items, “a set of” means one or more of the items. For example, “a set of clouds” is one or more different types of cloud environments.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor units 216 that are capable of executing program instructions 214 and implementing processes in the illustrative examples. In other words, program instructions 214 are computer-readable program instructions.

As used herein, a processor unit in processor units 216 is a hardware device and is comprised of hardware circuits such as those on an integrated circuit that respond to and process instructions and program code that operate a computer. When processor units 216 executes program instructions 214 for a process, processor units 216 can be one or more processor units that are in the same computer or in different computers. In other words, the process can be distributed between processor units 216 on the same or different computers in computer system 204.

Further, processor units 216 can be of the same type or different types of processor units. For example, processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes historical data 228 for aquifer parameters 226 collected from aquifers 232. Historical data 228 includes values for parameters in aquifer parameters 226 collected from aquifers 232 over a period of time. Aquifer parameters 226 are characteristic for aquifers 232. As depicted, aquifer parameters 226 can include aquifer size, aquifer thickness, aquifer depth, a petrophysical property, a pressure condition, a temperature condition, a fluid property, a solubility condition, a two-phase flow property, a porosity, a fracturing condition, a permeability, or other suitable parameters for aquifers 232.

Model manager 218 can use historical data 228 as input to numerical simulation models 224 to generate simulation data 234. In this illustrative example, historical data 228 can be used as input in a number of ways. For example, model manager 218 can generate a number of input files using different combinations of aquifer parameters in aquifer parameters 226. Each input file contains values for a combination of aquifer parameters based on historical data 228.

In this illustrative example, historical data 228 usually does not have sufficient data for training machine learning models for selecting aquifers. Therefore, generating simulation data 234 and including simulation data 234 in the training data makes the resulting machine learning model more accurate and efficient.

As depicted, input files generated using historical data 228 can be used as input for numerical simulation models 224. Numerical simulation models 224 are representations of real world systems that are used are created using computational tools and techniques. Numerical simulation models 224 are designed to simulate, analyze and predict the behavior of complex systems through mathematical algorithms and numerical simulations.

For example, numerical simulation models 224 can be numerical simulators that simulate behavior of aquifers 232 based on the input files. In this illustrative example, a simulation is performed for each input file to generate simulation data 234.

In this illustrative example, numerical simulation models 224 uses simulation parameters 222 for running simulations. Simulation parameters 222 are characteristic for aquifers 232 that provide information for training machine learning models to select aquifers for carbon storage. For example, simulation parameters 222 can be different combinations of parameters in aquifer parameters 226.

Simulation parameters 222 includes selected simulation parameters 252. Selected simulation parameters 252 can be a subset of simulation parameters 222 and are parameters in simulation parameters 222 that are selected for generating simulation data 234. In other words, simulation data 234 are values for selected simulation parameters 252.

For example, simulation parameters 222 and selected simulation parameters 252 can include at least one of wellbore pressure, reservoir pressure, injection rate, cumulative injection, or combination of parameters. In this example, simulation data 234 can include wellbore pressure and reservoir pressure for a period of time for aquifers 232, and injection rate and cumulative injection for a period of time for aquifers 232.

In another example, simulation data 234 can include wellbore pressure and reservoir pressure in increments of pressure for aquifers 232, and injection rate and cumulative injection in increments of pressure for aquifers 232. In this illustrative example, increments of pressure are values of pressure between the initial aquifer pressure and the fracture pressure. In other words, wellbore pressure, reservoir pressure, injection rate, and cumulative injection can be calculated at increments of pressure.

In this illustrative example, model manager 218 uses simulation data 234 to generate auxiliary quantities 238. Auxiliary quantities 238 are values for auxiliary parameters 242. Auxiliary parameters 242 are variables that represent deviation between a simplified model and reality. Auxiliary parameters 242 can also be referred to as “skin term”.

In this illustrative example, the simplified model is a mathematical relationship that employs simplified assumptions to represent behaviors for aquifers 232. For example, the simplified model can be mathematical relationships from physics-based equations 240 that do not take auxiliary parameters 242 into account. In other words, the simplified model is a mathematical relationship that does not take auxiliary parameters 242 into account and therefore cannot generate accurate predictions to forecast behavior for aquifers 232.

In this illustrative example, auxiliary parameters 242 can be positive or negative, with the absolute values of auxiliary parameters 242 indicate the extent of deviation. In other words, auxiliary parameters 242 can be included as part of the training data to improve accuracy of machine learning model.

In this illustrative example, auxiliary quantities 238 for auxiliary parameters 242 can be generated using physics-based equations 240. Physics-based equations 240 are reservoir engineering equations. In this illustrative example, reservoir engineering equations are mathematical relationships used to analyze and model the behavior of fluids within underground reservoirs.

In this illustrative example, physics-based equations 240 include a material balance equation that defines relation between average reservoir pressure and cumulative carbon dioxide injected into an aquifer. The material balance equation is as follows:

p̅(t)−pᵢ=B_{g}∫q(t)dt/AhØcₜ (1)

Where p̅(t) is the average reservoir pressure, q(t) is the injection rate, ∫q(t)dt is the cumulative value of the injected carbon dioxide, A is the reservoir area, h is the reservoir thickness, Ø is the porosity, B_{g} is the gas formation volume factor, pᵢ is initial reservoir pressure, and cₜ is the total compressibility of rock and fluid in aquifer.

In this illustrative example, compression refers to the reduction in volume of a substance when pressure is applied, and compressibility refers to how much the rock and fluid can be squeezed when pressure is applied.

Material balance equation provides a relationship that is crucial for selecting aquifers for carbon storage. In this illustrative example, the relationship between average reservoir pressure and cumulative volume of carbon dioxide injected is one of the key features for selecting aquifers for carbon storage because the cumulative volume of carbon dioxide injected is the total amount of gas that can be injected into aquifers, and average reservoir pressure is the limit to which capacity is determined.

In this illustrative example, the material balance equation is designed for water injection into a water reservoir. However, such an assumption can be corrected by inputting simulation data 234 into physics-based equations 240. In other words, the material balance equation can properly model carbon dioxide injection into an aquifer to provide an accurate relationship between average reservoir pressure and cumulative carbon dioxide injection upon using simulation data 234 as inputs.

In addition, physics-based equations 240 can also include a deliverability equation that defines the relationship between injection rate and difference between average reservoir pressure and wellbore pressure for the aquifers. The deliverability equation is as follows:

$$q ( t ) = \frac{2 π kh}{{B}_{g} {μ}_{w}} \frac{{p}_{w} ( t ) - \overline{p} ( t )}{ln ( \frac{{r}_{e}}{{r}_{w}} ) - 0.75 + S ( t )} \qquad ( 2 )$$

where p_{w}(t) is the maximum injection pressure, q(t) is the injection rate, μ_{w} is the water viscosity, rₑ is the external radius of aquifers, r_{w} is the wellbore radius for aquifers, k is the permeability of aquifers, h is the thickness for aquifers, B_{g} is the gas formation volume factor, p̅(t) is the average reservoir pressure, and S(t) is the value for skin term that can be used as auxiliary quantities 238 for auxiliary parameters 242.

In this illustrative example, simulation data 234 and auxiliary quantities 238 are used to form training dataset 236. In another example, training dataset 236 can also include historical data 228 for aquifer parameters 226 as part of training dataset 236.

Computer system 204 further includes machine intelligence 212. Machine intelligence 212 includes machine learning models 248 and machine learning algorithms 250. Machine learning is a branch of artificial intelligence (AI) that enables computers to detect patterns and improve performance without direct programming commands. Rather than relying on direct input commands to complete a task, machine learning relies on input data. The data is fed into the machine, one of machine learning algorithms 250 is selected, parameters for the data are configured, and the machine is instructed to find patterns in the input data through optimization algorithms. The data model formed from analyzing the data is then used to predict future values. In this illustrative example, the learning of the machine learning models 248 can be achieved through a database input that is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching for machine learning models 248.

In addition, machine intelligence 212 can also include deep learning and deep learning algorithms. Deep learning is a method of artificial intelligence that mimics the human brain's capacity to learn and adapt. Deep learning utilizes neural networks that have multiple layers for identifying and learning features from data. In this illustrative example, deep learning can use an iterative process such as backpropagation and gradient descent to refine its parameters to make accurate predictions by minimizing the difference between outputs and actual results.

Machine intelligence 212 can be implemented using one or more systems such as an artificial intelligence system, a neural network, a generative adversarial network, a generative neural network, a Bayesian network, an expert system, a fuzzy logic system, a genetic algorithm, or other suitable types of systems. In this illustrative example, machine learning models 248 and machine learning algorithms 250 may make computer system 204 a special purpose computer for generating machine learning models for selecting aquifers for carbon storage.

Machine learning models 248 involves using machine learning algorithms 250 to build machine intelligence 212 based on samples of data such as training dataset 236. In other words, machine learning models 248 are trained using training dataset 236.

As depicted, machine intelligence 212 includes machine learning models 248 that can be trained using training dataset 236. Machine intelligence 212 can be used to make predictions without being explicitly programmed to make these predictions and can be trained and retrained for a number of different types of applications. These applications include, for example, medicine, financial services, healthcare, speech recognition, computer vision, or other types of applications.

Machine learning algorithms 250 can include supervised machine learning algorithms, unsupervised machine learning algorithms, and self-learning algorithms. Supervised machine learning can train machine learning models using data containing both the inputs and desired outputs. Examples of machine learning algorithms include XGBoost, K-means clustering, and random forest.

In addition, SHapley Additive explanation (SHAP) tool can be used to confirm that machine learning models 248 accurately captures effect of various parameters. In other words, SHapley Additive explanation tool can be used to verify the reliability of machine learning model 248.

In this illustrative example, machine learning models 248 can be used to select aquifers that meet a set of requirements for storing carbon dioxide. For example, machine learning models 248 can be used to select set of aquifers 230 that meet the requirements from carbon storage requirements 220. Carbon storage requirements 220 define conditions for storing carbon dioxide in underground geological formations. In this illustrative example, an aquifer can be a type of underground carbon storage.

In this illustrative example, carbon storage requirements 220 can include capacity, injection rate, a rate of carbon storage, or any parameters and characteristics for aquifers that can be used for determining whether an aquifer is suitable for carbon storage.

In this illustrative example, the set of aquifers 230 can be aquifers at a single storage site that meets requirements in carbon storage requirements 220. In another illustrative example, the set of aquifers 230 can be a ranked list of single storage sites that meets requirements in carbon storage requirements 220. In yet another illustrative example, the set of aquifers 230 can be multiple aquifers that meet the requirements in carbon storage requirements 220.

In this illustrative example, user 206 can interact with computer system 204 to coordinate generation of machine learning models 248. User 206 can be an example of user 126 in FIG. 1. Computer system 204 can receive a user input 208 from user 206.

In this example, user input 208 can be generated by user 206 using human machine interface (HMI) 210. As depicted, human machine interface 210 includes display system 244 and input system 246. Display system 244 is a physical hardware system and includes one or more display devices on which graphical user interface 256 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this illustrative example, graphical user interface 256 can be used to display information to user 206. For example, graphical user interface 256 can display simulation data 234, historical data 228, analysis for aquifers 232 and set of aquifers 230, or any information associated with aquifers 232 and set of aquifers 230.

In this example, user 206 is a person that can interact with graphical user interface 256 through user input 208 generated by input system 246. Input system 246 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device.

In this illustrative example, user 206 can review information associated with set of aquifers 230 to determine accuracy of machine learning models 248 using graphical user interface 256. For example, user 206 can review information associated with set of aquifers 230 to determine whether set of aquifers 230 meet the requirements from carbon storage requirements 220. After reviewing, user 206 can provide feedback 254 through user input 208 to model manager 218.

Model manager 218 can also use feedback 254 to perform retraining of machine learning models 248 to improve machine intelligence 212. In this illustrative example, machine learning algorithms 250 in machine intelligence 212 can use feedback from feedback 254 in user input 208 received from user 206 to retrain machine learning models 248 such that accuracy and quality of prediction generated by machine learning models 248 can be improved over time.

In one illustrative example, one or more solutions are present that overcome a problem with constructing machine learning models for selecting aquifers for carbon storage. As a result, one or more technical solutions may provide an ability to increase efficiency and accuracy in selecting for carbon storage. Thus, the inconveniences and errors from manually updating source code in different versions can be reduced.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 218 in computer system 204 enables managing the execution of generating training dataset 236, training of machine learning models 248, assessing performance for machine learning models 248, and retraining of machine learning models 248. In particular, model manager 218 transforms computer system 204 into a special purpose computer system as compared to currently available general computer systems that do not have model manager 218.

In the illustrative example, the use of model manager 218 in computer system 204 integrates processes into a practical application for generating training data and constructing computation model using the training data to increases the performance of computer system 204. In other words, model manager 218 in computer system 204 is directed to a practical application of processes integrated into model manager 218 in computer system 204 that constructs machine learning models for selecting aquifers for carbon storage.

The illustration of aquifer management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, set of aquifers 230 and aquifers 232 can share at least a portion of aquifers.

In another example, model manager 218 can also be configured to select multi-well aquifers when single-well aquifers are not sufficient for carbon storage. In this illustrative example, selected simulation parameters 252 can include “number of wells” and “well arrangement” such as spacing between wells such that simulation data 234 is also accounted for multi-well situations.

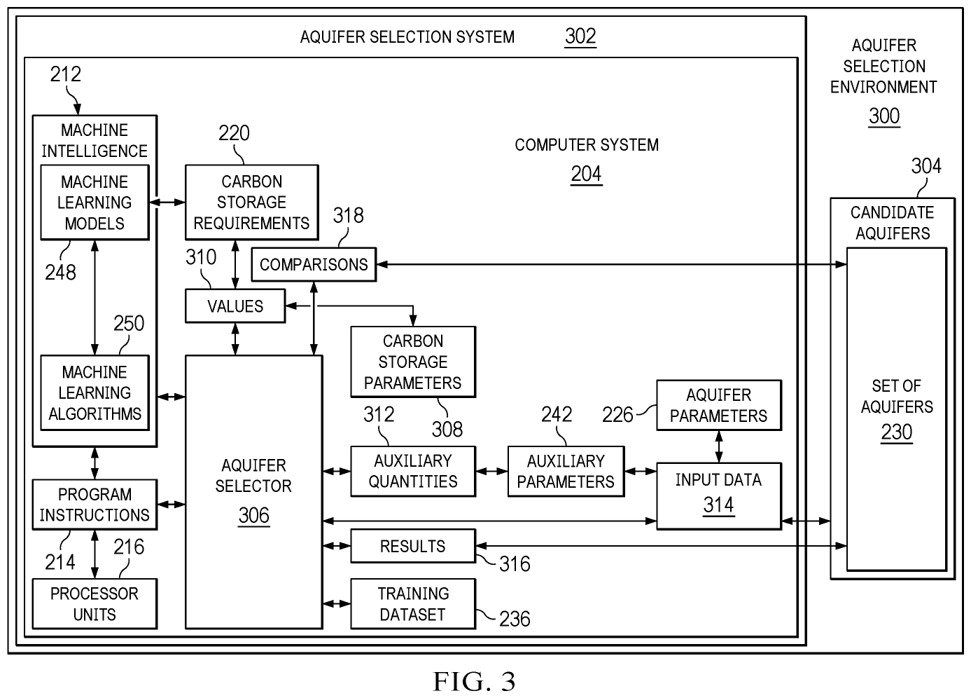

With reference now to FIG. 3, an illustration of a block diagram of an aquifer selection environment is depicted in accordance with an illustrative embodiment. In this illustrative example, aquifer selection environment 300 includes components that can be implemented in hardware such as the hardware shown in network data processing system 100 in FIG. 1.

In the illustrative examples, the same reference numeral may be used in more than one figure. This reuse of a reference numeral in different figures represents the same element in the different figures.

In this illustrative example, aquifer selection system 302 in aquifer selection environment 300 uses information received from candidate aquifers 304 to select set of aquifers 230 that meet the requirements in carbon storage requirements 220 for carbon storage.

In this illustrative example, aquifer selection system 302 includes computer system 204 and aquifer selector 306. Aquifer selector 306 is located in computer system 204. Aquifer selector 306 can be an example of aquifer selector 132 in FIG. 1.

Aquifer selector 306 can be implemented in software, hardware, firmware, or a combination thereof. When software is used, the operations performed by aquifer selector 306 can be implemented in program instructions configured to run on hardware, such as a processor unit. When firmware is used, the operations performed by aquifer selector 306 can be implemented in program instructions and data and stored in persistent memory to run on a processor unit. When hardware is employed, the hardware can include circuits that operate to perform the operations in aquifer selector 306.

As depicted, machine intelligence 212 includes machine learning models 248 trained using training dataset 236. In this illustrative example, aquifer selector 306 receives input data 314 for aquifer parameters 226. Input data 314 are values for aquifer parameters 226 for candidate aquifers 304.

In this illustrative example, aquifer selector 306 uses machine learning models 248 to determine auxiliary quantities 312 based on auxiliary parameters 242 from input data 314 for aquifer parameters 226. In this illustrative example, aquifer selector 306 can use machine learning models 248 with auxiliary quantities 312 to determine values 310 for carbon storage parameters 308. Carbon storage parameters 308 are parameters that can be used for determining whether an aquifer in candidate aquifers 304 is suitable for carbon storage. For example, carbon storage parameters 308 can include capacity, injection rate, or a rate of carbon storage.

Aquifer selector 306 compares values 310 to carbon storage requirements 220 to form comparisons 318. In other words, comparisons 318 provides indications on whether aquifers in candidate aquifers 304 meet requirements in carbon storage requirements 220 for carbon storage.

In this illustrative example, aquifer selector 306 selects set of aquifers 230 in candidate aquifers 304 based on comparisons 318. In other words, set of aquifers 230 are aquifers from candidate aquifers 304 that meet the requirements in carbon storage requirements 220 for carbon storage. In this illustrative example, carbon dioxide can be stored in set of aquifers 230 after selection for set of aquifers 230 is made by aquifer selector 306.

In this illustrative example, aquifer selector 306 can also generate results 316 for set of aquifers 230 using machine learning models 248 based on input data 314 for aquifer parameters 226. Results 316 can include analysis and decisions associated with carbon storage for set of aquifers 230. For example, results 316 can include an order in which carbon dioxide is to be stored in set of aquifers 230. In another example, results 316 can include a rate at which carbon dioxide is to be stored in set of aquifers 230.

In one illustrative example, one or more solutions are present that overcome a problem with selecting aquifers for carbon storage. As a result, one or more technical solutions may provide an ability to increase efficiency and accuracy in selecting aquifers for carbon storage. Thus, the inconveniences and errors from manually updating source code in different versions can be reduced.

In a similar fashion, computer system 204 operates as a special purpose computer system in which aquifer selector 306 in computer system 204 enables managing the execution of selecting set of aquifers 230 that meet requirements in carbon storage requirements 220 using machine learning models 248 and generate results 316 for set of aquifers 230 using machine learning models 248. In particular, aquifer selector 306 transforms computer system 204 into a special purpose computer system as compared to currently available general computer systems that do not have aquifer selector 306.

In a similar fashion, the use of aquifer selector 306 in computer system 204 integrates processes into a practical application for selecting aquifers for carbon storage. In other words, aquifer selector 306 in computer system 204 is directed to a practical application of processes integrated into aquifer selector 306 in computer system 204 that selects aquifers for carbon storage.

The illustration of aquifer selection environment 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, comparisons 318 can be generated as part of results 316 using machine learning models 248.

In another example, aquifer selector 306 can also take incomplete data or uncertainties from input data 314 into account. In this illustrative example, aquifer selector 306 can use default value for aquifer parameters in incomplete data from input data 314 and Monte-Carlo simulation to estimate range of values to account for uncertainties in input data 314.

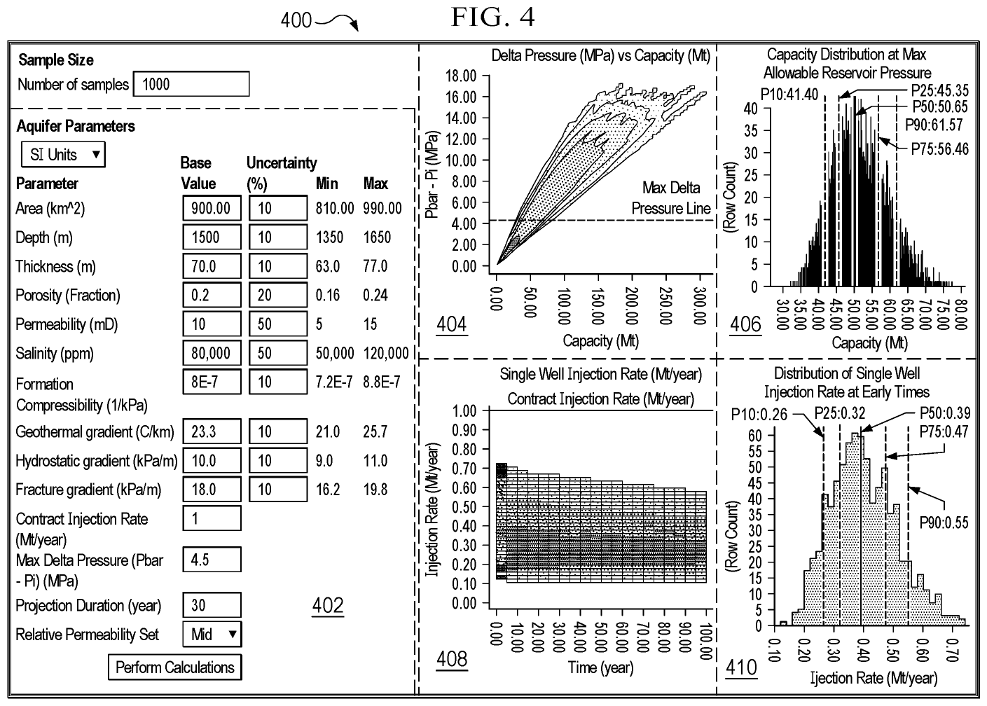

FIG. 4 depicts a diagram illustrating a user interface in accordance with an illustrative embodiment. In this illustrative example, the user interface illustrated in FIG. 4 can be an example of graphical user interface 256 displayed using display system 244 in

FIG. 2.

In FIG. 4, an analysis of a single aquifer is displayed in user interface 400. User interface 400 is divided into different sections for presenting analysis for an aquifer. In this illustrative example, input area 402 presents a portion of user interface 400 for inputting aquifer parameters for the aquifer.

In addition, a number of plots can be presented in user interface 400. For example, Plot 404 presents increment of pressure in relation to capacity of the aquifer for the aquifer parameters input through input area 402. Plot 404 is colored by density of data points representing number of samples provided in input area 402.

In this illustrative example, the color plot can be considered as visual guides displaying how the numerical data, grouped into intervals, spreads across both the horizontal (x) and vertical (y) axes. The color plot can provide a clear picture of the probable distribution of data. For example, regions exhibiting a density higher than the median are represented by various colors, indicating the most probable areas for generated samples. The max increment of pressure line on plot 404 depicts the value input through input area 402.

Plot 406 presents capacity distribution of aquifer at maximum allowable reservoir pressure for the aquifer parameters input through input area 402. In this example, plot 406 presents detailed distribution of capacities on max increment of pressure line on plot 404.

Plot 408 presents single well injection rate of the aquifer over time for the aquifer parameters input through input area 402. Plot 408 is colored based on the density of data points, providing a visual representation of the most probable injection rates for generated samples. The Contract Injection Rate (Mt/year) line on plot 408 depicts the value input through input area 402.

In addition, Plot 410 presents a detailed distribution of injection rates at early times for the number of samples provided in input area 402.

It should be understood that the presentation of plots in FIG. 4 is only one embodiment of the present disclosure. For example, other types of analysis can also be displayed using user interface 400.

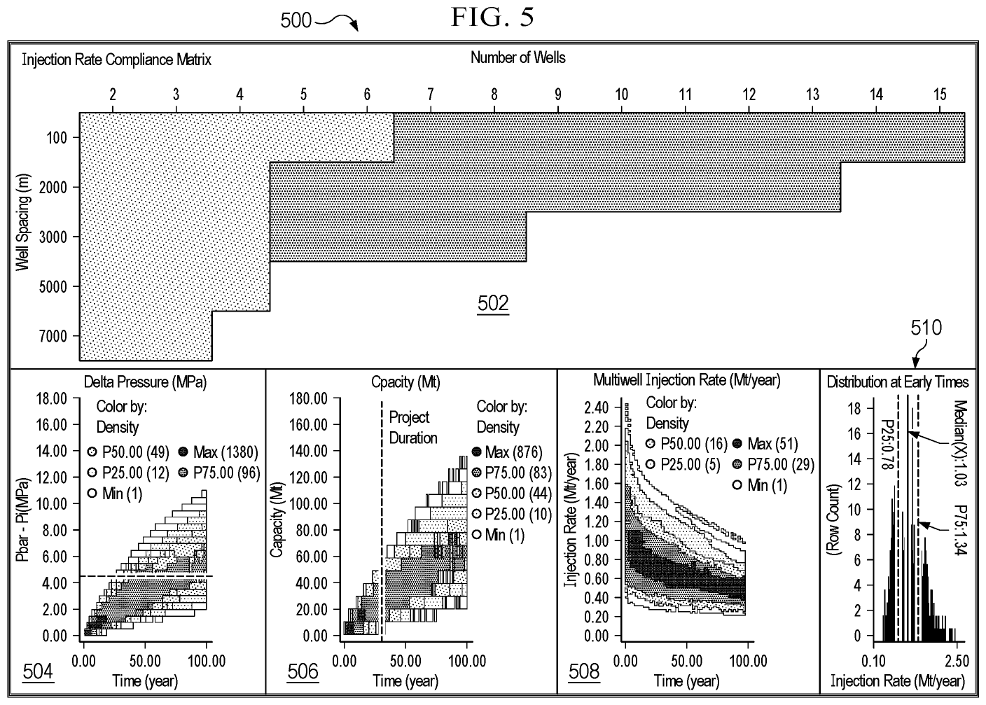

FIG. 5 depicts a diagram illustrating a user interface in accordance with an illustrative embodiment. In this illustrative example, the user interface illustrated in FIG. 5 can be an example of graphical user interface 256 displayed using display system 244 in FIG. 2.

In the illustrative examples, the same reference numeral may be used in more than one figure. This reuse of a reference numeral in different figures represents the same element in the different figures.

In FIG. 5, an analysis for multi-well aquifer is displayed in user interface 500. In a similar fashion, user interface 500 is divided into different sections for presenting analysis for a multi-well aquifer.

A number of plots can be presented in user interface 500. For example, plot 502 presents injection rate compliance matrix for a multi-well aquifer. The injection rate compliance matrix displays potential configuration for the number of wells and well spacing based on input values provided in input area 402 in FIG. 4. The different colors indicate cells that either meet or do not meet the specified contract injection rate value provided in input area 402. In this illustrative example, user interface 500 can be interactive such that a click on any cell within the matrix to see the corresponding relevant plots such as plot 504, 506, 508, and 510.

Plot 504 presents increments of pressure over time for number of samples provided in input area 402 in FIG. 4. Plot 504 is colored based on density of data points. The max increment of pressure line on plot 504 depicts the value input through input area 402.

Plot 506 presents capacity over time for the number of samples provided in input area 402 in FIG. 4. In a similar fashion, plot 506 is colored based on density of data points. In plot 506, the project duration line on plot 506 depicts the value input through input area 402.

Plot 508 presents multi-well injection rate over time for the number of samples provided in input area 402. Plot 508 is colored based on density of data points.

Plot 510 presents a detailed distribution of multi-well injection rates at early times for number of samples provided in input area 402 in FIG. 4.

It should also be understood that the presentation of plots in FIG. 5 is only one embodiment of the present disclosure. For example, other types of analysis can also be displayed using user interface 500.

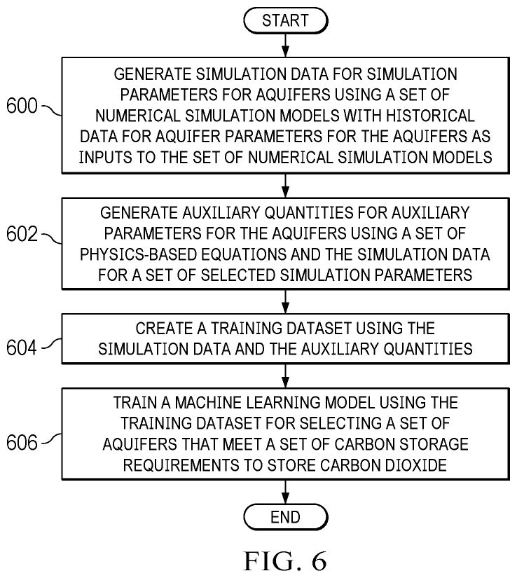

FIG. 6 depicts a flowchart illustrating a process for training a machine learning model to select aquifers for carbon storage in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in model manager 218 in computer system 204 in FIG. 2.

The process begins by generating simulation data for simulation parameters for aquifers using a set of numerical simulation models with historical data for aquifer parameters for the aquifers as inputs to the set of numerical simulation models (step 600).

The process generates auxiliary quantities for auxiliary parameters for the aquifers using a set of physics-based equations and the simulation data for a set of selected simulation parameters (step 602). The process creates a training dataset using the simulation data and the auxiliary quantities (step 604).

The process trains a machine learning model using the training dataset for selecting a set of aquifers that meet a set of carbon storage requirements to store carbon dioxide (step 606). The process terminates thereafter.

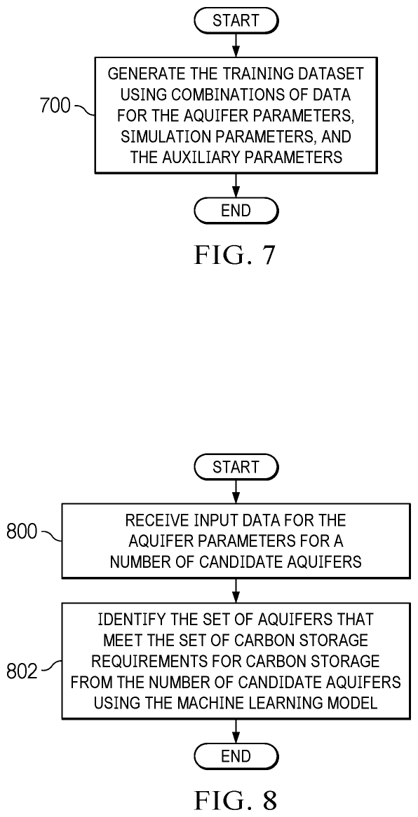

Turning next to FIG. 7, a flowchart of a process for generating a training dataset is depicted in accordance with an illustrative embodiment. The process in this flowchart is an example of an implementation for step 604 in FIG. 6.

The process begins by generating the training dataset using combinations of data for the aquifer parameters, simulation parameters, and the auxiliary parameters (step 700). The process terminates thereafter.

Turning next to FIG. 8, a flowchart of a process for identifying aquifers to store carbon dioxide is depicted in accordance with an illustrative embodiment. The process in this figure is an example of an additional step that can be performed with the steps in FIG. 6.

The process begins by receiving input data for the aquifer parameters for a number of candidate aquifers (step 800). The process identifies the set of aquifers that meet the set of carbon storage requirements for carbon storage from the number of candidate aquifers using the machine learning model (step 802). The process terminates thereafter.

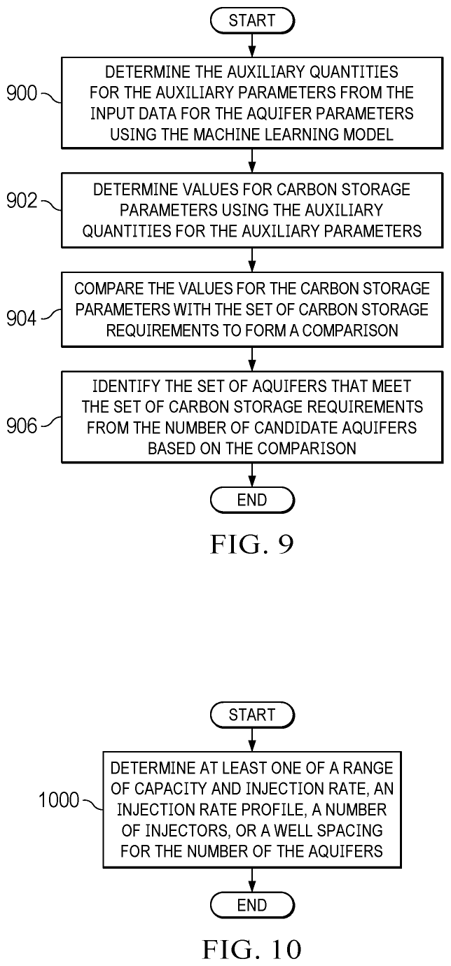

Turning next to FIG. 9, a flowchart of a process for identifying aquifers using the machine learning model is depicted in accordance with an illustrative embodiment. The process in this flowchart is an example of an implementation for step 802 in FIG. 8.

The process begins by determining the auxiliary quantities for the auxiliary parameters from the input data for the aquifer parameters using the machine learning model (step 900). The process determines values for carbon storage parameters using the auxiliary quantities for the auxiliary parameters (step 902). The process compares the values for the carbon storage parameters with the set of carbon storage requirements to form a comparison (step 904). The process identifies the set of aquifers that meet the set of carbon storage requirements from the number of candidate aquifers based on the comparison (step 906). The process terminates thereafter.

Turning next to FIG. 10, a flowchart of a process for generating output for selecting aquifers for carbon storage is depicted in accordance with an illustrative embodiment. The process in this figure is an example of an additional step that can be performed with the steps in FIG. 9.

The process begins by determining at least one of a range of capacity and injection rate, an injection rate profile, a number of injectors, or a well spacing for the number of the aquifers (step 1000). The process terminates thereafter.

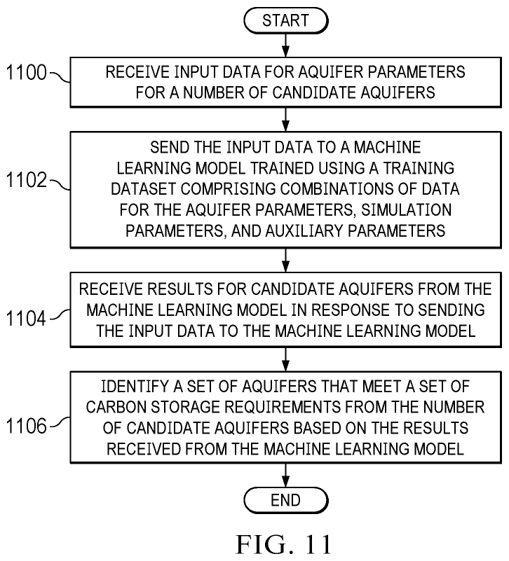

Turning next to FIG. 11, a flowchart of a process for storing carbon dioxide is depicted in accordance with an illustrative embodiment. The process in FIG. 11 can be implemented in hardware, software, or both. When implemented in software, the process can take the form of program instructions that are run by one of more processor units located in one or more hardware devices in one or more computer systems. For example, the process can be implemented in aquifer selector 306 in computer system 204 in FIG. 3.

The process begins by receiving input data for aquifer parameters for a number of candidate aquifers (step 1100). The process sends the input data to a machine learning model trained using a training dataset comprising combinations of data for the aquifer parameters, simulation parameters, and auxiliary parameters (step 1102). The process receives results for candidate aquifers from the machine learning model in response to sending the input data to the machine learning model (step 1104). The process identifies a set of aquifers that meet a set of carbon storage requirements from the number of candidate aquifers based on the results received from the machine learning model (step 1106). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

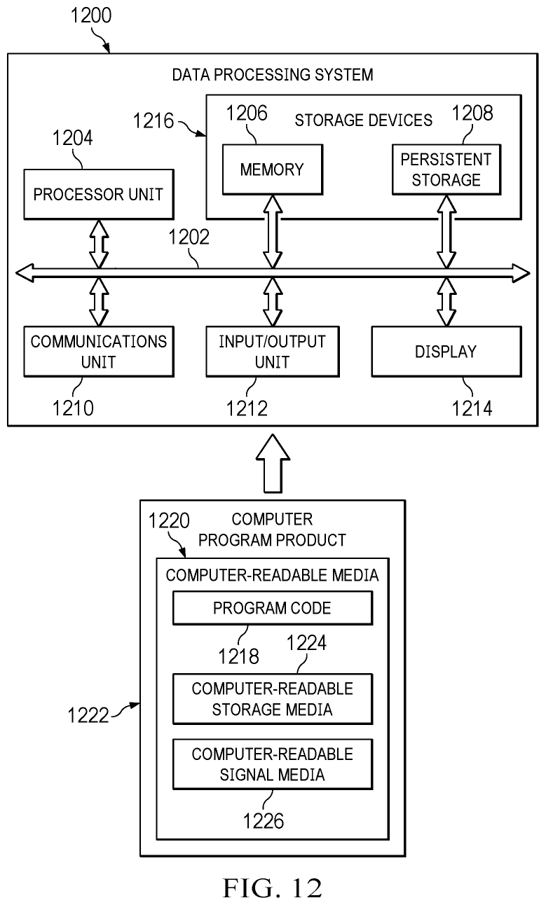

Turning now to FIG. 12, an illustration of a block diagram of a data processing system is depicted in accordance with an illustrative embodiment. Data processing system 1200 may be used to implement server computer 104 and server computer 106 and client devices 110 in FIG. 1, as well as computer system 204 in FIG. 2 and FIG. 3. In this illustrative example, data processing system 1200 includes communications framework 1202, which provides communications between processor unit 1204, memory 1206, persistent storage 1208, communications unit 1210, input/output unit 1212, and display 1214. In this example, communications framework 1202 may take the form of a bus system.

Processor unit 1204 serves to execute instructions for software that may be loaded into memory 1206. Processor unit 1204 may be a number of processors, a multi-processor core, or some other type of processor, depending on the particular implementation. In an embodiment, processor unit 1204 comprises one or more conventional general-purpose central processing units (CPUs). In an alternate embodiment, processor unit 1204 comprises one or more graphical processing units (GPUS).

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208. Communications unit 1210, in these illustrative examples, provides for communications with other data processing systems or devices. In these illustrative examples, communications unit 1210 is a network interface card.

Input/output unit 1212 allows for input and output of data with other devices that may be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs may be located in storage devices 1216, which are in communication with processor unit 1204 through communications framework 1202. The processes of the different embodiments may be performed by processor unit 1204 using computer-implemented instructions, which may be located in a memory, such as memory 1206.

These instructions are referred to as program code, computer-usable program code, or computer-readable program code that may be read and executed by a processor in processor unit 1204. The program code in the different embodiments may be embodied on different physical or computer-readable storage media, such as memory 1206 or persistent storage 1208.

Program code 1218 is located in a functional form on computer-readable media 1220 that is selectively removable and may be loaded onto or transferred to data processing system 1200 for execution by processor unit 1204. Program code 1218 and computer-readable media 1220 form computer program product 1222 in these illustrative examples. In one example, computer-readable media 1220 may be computer-readable storage media 1224 or computer-readable signal media 1226.

In these illustrative examples, computer-readable storage media 1224 is a physical or tangible storage device used to store program code 1218 rather than a medium that propagates or transmits program code 1218. Computer-readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1218 may be transferred to data processing system 1200 using computer-readable signal media 1126. Computer-readable signal media 1226 may be, for example, a propagated data signal containing program code 1218. For example, computer-readable signal media 1226 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1200 are not meant to provide architectural limitations to the manner in which different embodiments may be implemented. The different illustrative embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code 1218.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An aquifer management system comprising:
a computer system;
a model manager configured to:
generate simulation data for simulation parameters for aquifers using a set of numerical simulation models with historical data for aquifer parameters for the aquifers as inputs to the set of numerical simulation models;
generate auxiliary quantities for auxiliary parameters for the aquifers using a set of physics-based equations and the simulation data for a set of selected simulation parameters;
create a training dataset using the simulation data and the auxiliary quantities; and
train a machine learning model using the training dataset to select a set of aquifers that meet a set of carbon storage requirements to store carbon dioxide.

2. The aquifer management system of claim 1, wherein creating the training dataset using the simulation data and the auxiliary quantities, the model manager is configured to:
generate the training dataset using combinations of data for the aquifer parameters, simulation parameters, and the auxiliary parameters.

3. The aquifer management system of claim 1, wherein the set of carbon storage requirement are selected from at least one of capacity, injection rate, or a rate of carbon storage.

4. The aquifer management system of claim 1, wherein the set of aquifers are at a single storage site that meets the set of carbon storage requirements.

5. The aquifer management system of claim 1, wherein the set of aquifers are a ranked list of single storage sites that meets the set of carbon storage requirements.

6. The aquifer management system of claim 1, wherein the set of aquifers are multiple aquifers that meet the set of carbon storage requirements.

7. The aquifer management system of claim 1, wherein the machine learning model determines an arrangement of multiple wells in an aquifer that meets the set of carbon storage requirements.

8. The aquifer management system of claim 1, wherein the set of physics-based equations are reservoir engineering equations.

9. The aquifer management system of claim 8, wherein the reservoir engineering equations is selected from at least one of a material balance equation and a deliverability equation, wherein the material balance equation defines relationship between average reservoir pressure and cumulative carbon dioxide injected for the aquifers, and wherein the deliverability equation defines relation between injection rate and difference between average reservoir pressure and wellbore pressure for the aquifers.

10. The aquifer management system of claim 9, wherein the material balance equation is:
$$\overline{p} ( t ) - {p}_{i} = \frac{{B}_{g} \int q ( t ) dt}{Ah ∅ {c}_{t}} .$$

11. The aquifer management system of claim 9, wherein the deliverability equation is:
$$q ( t ) = \frac{2 π kh}{{B}_{g} {μ}_{w}} \frac{{p}_{w} ( t ) - \overline{p} ( t )}{ln ( \frac{{r}_{e}}{{r}_{w}} ) - 0.75 + S ( t )} .$$

12. The aquifer management system of claim 1, wherein the aquifer parameters are selected from at least one of aquifer size, aquifer thickness, aquifer depth, a petrophysical property, a pressure condition, a temperature condition, a fluid property, a solubility condition, a two-phase flow property, a porosity, a fracturing condition, or a permeability.

13. The aquifer management system of claim 1, wherein the simulation parameters are selected from at least one of wellbore pressure, reservoir pressure, injection rate, and cumulative injection.

14. The aquifer management system of claim 1 further comprising:
an aquifer selector configured to:
select the set of aquifers from a number of candidate aquifers that meet the set of carbon storage requirements to store carbon dioxide using the machine learning model trained using the training dataset.

15. The aquifer management system of claim 14, wherein selecting the set of aquifers from the number of candidate aquifers that meet the set of carbon storage requirements to store carbon dioxide using the machine learning model trained using the training dataset, the aquifer selector is configured to:
determine auxiliary quantities for the auxiliary parameters from the input data for the aquifer parameters using the machine learning model;
determine values for carbon storage parameters using the auxiliary quantities for the auxiliary parameters;
compare the values for the carbon storage parameters with the set of carbon storage requirements to form a comparison; and
identify the set of aquifers from the number of candidate aquifers that meet a set of carbon storage requirements based on the comparison.

16. The aquifer management system of claim 14, wherein the aquifer selector is configured to:
determine at least one of a range of capacity and injection rate, an injection rate profile, a number of injectors, or a well spacing for the number of the aquifers.

17. The aquifer management system of claim 14, wherein the machine learning model also determines an order in which carbon dioxide is to be stored in the set of aquifers.

18. The aquifer management system of claim 14, wherein the machine learning model also determines a rate at which carbon dioxide is to be stored in the set of aquifers.

19. The aquifer management system of claim 1, wherein the simulation parameters for the aquifers comprise different combinations of aquifer parameters for the aquifers.

20. A computer implemented method for training a machine learning model to select aquifers for carbon storage, the computer implemented method comprising:
generating, by a number of processor units, simulation data for simulation parameters for aquifers using a set of numerical simulation models with historical data for aquifer parameters for the aquifers as inputs to the set of numerical simulation models;
generating, by the number of processor units, auxiliary quantities for auxiliary parameters for the aquifers using a set of physics-based equations and the simulation data for a set of selected simulation parameters;
creating, by the number of processor units, a training dataset using the simulation data and the auxiliary quantities; and
training, by the number of processor units, a machine learning model using the training dataset for selecting a set of aquifers that meet a set of carbon storage requirements to store carbon dioxide.

21. The computer implemented method of claim 20, wherein creating, by the number of processor units, a training dataset using the simulation data and the auxiliary quantities comprises:
generating, by the number of processors, the training dataset using combinations of data for the aquifer parameters, simulation parameters, and the auxiliary parameters.

22. The computer implemented method of claim 20, wherein the set of carbon storage requirements are selected from at least one of capacity, injection rate, or a rate of carbon storage.

23. The computer implemented method of claim 20, wherein the set of aquifers are at a single storage site that meets the set of carbon storage requirements.

24. The computer implemented method of claim 20, wherein the set of aquifers is a ranked list of single storage sites that meets the set of carbon storage requirements.

25. The computer implemented method of claim 20, wherein the set of aquifers are multiple aquifers that meet the set of carbon storage requirements.

26. The computer implemented method of claim 20, wherein the machine learning model determines an arrangement of multiple wells in an aquifer that meets the set of carbon storage requirements.

27. The computer implemented method of claim 20, wherein the set of physics-based equations are reservoir engineering equations.

28. The computer implemented method of claim 20, wherein the reservoir engineering equations is selected from at least one of a material balance equation and a deliverability equation, wherein the material balance equation defines relationship between average reservoir pressure and cumulative carbon dioxide injected for the aquifers, and wherein the deliverability equation defines relation between injection rate and difference between average reservoir pressure and wellbore pressure for the aquifers.

29. The computer implemented method of claim 28, wherein the material balance equation is:
$$\overline{p} ( t ) - {p}_{i} = \frac{{B}_{g} \int q ( t ) dt}{Ah ∅ {c}_{t}} .$$

30. The computer implemented method of claim 28, wherein the deliverability equation is:
$$q ( t ) = \frac{2 π kh}{{B}_{g} {μ}_{w}} \frac{{p}_{w} ( t ) - \overline{p} ( t )}{ln ( \frac{{r}_{e}}{{r}_{w}} ) - 0.75 + S ( t )} .$$

31. The computer implemented method of claim 20, wherein the aquifer parameters are selected from at least one aquifer size, aquifer thickness, aquifer depth, a petrophysical property, a pressure condition, a temperature condition, a fluid property, a solubility condition, a two-phase flow property, a porosity, a fracturing condition, or a permeability.

32. The computer implemented method of claim 20, wherein the simulation parameters are selected from at least one of wellbore pressure, reservoir pressure, injection rate, and cumulative injection.

33. The computer implemented method of claim 20 further comprising:
receiving, by the number of processor units, input data for the aquifer parameters for a number of candidate aquifers; and
identifying, by the number of processor units, the set of aquifers that meet the set of carbon storage requirements for carbon storage from the number of candidate aquifers using the machine learning model.

34. The computer implemented method of claim 33, wherein identifying, by the number of processor units, the set of aquifers that meet the set of carbon storage requirements for carbon storage from the number of candidate aquifers using the machine learning model comprises:
determining, by the number of processor units, the auxiliary quantities for the auxiliary parameters from the input data for the aquifer parameters using the machine learning model;
determining, by the number of processor units, values for carbon storage parameters using the auxiliary quantities for the auxiliary parameters;
comparing, by the number of processor units, the values for the carbon storage parameters with the set of carbon storage requirements to form a comparison; and
identifying, by the number of processor units, the set of aquifers that meet the set of carbon storage requirements from the number of candidate aquifers based on the comparison.

35. The computer implemented method of claim 34 further comprising:
determining, by the number of processor units, at least one of a range of capacity and injection rate, an injection rate profile, a number of injectors, or a well spacing for the number of the aquifers.

36. The computer implemented method of claim 20, wherein the simulation parameters for the aquifers comprise different combinations of aquifer parameters for the aquifers.

37. A computer implemented method for storing carbon dioxide, the computer implemented method comprising:
receiving, by a number of processor units, input data for aquifer parameters for a number of candidate aquifers;
sending, by the number of processor units, the input data to a machine learning model trained using a training dataset comprising combinations of data for the aquifer parameters, simulation parameters, and auxiliary parameters;
receiving, by the number of processor units, results for candidate aquifers from the machine learning model in response to sending the input data to the machine learning model; and
identifying, by the number of processor units, a set of aquifers that meet a set of carbon storage requirements from the number of candidate aquifers based on the results received from the machine learning model.

38. The computer implemented method of claim 37, wherein the results comprise an order in which carbon dioxide is to be stored in the set of aquifers.

39. The computer implemented method of claim 37, wherein the results comprise a rate at which carbon dioxide is to be stored in the set of aquifers.

40. A computer program product for training a machine learning model to select aquifers for carbon storage, the computer program product comprising:
a set of one or more computer-readable storage media;
program instructions, collectively stored in the set of one or more storage media, cause a number of processor units to perform the following computer operations:
generate simulation data for simulation parameters for aquifers using a set of numerical simulation models with historical data for aquifer parameters for the aquifers as inputs to the set of numerical simulation models;
generate auxiliary quantities for auxiliary parameters for the aquifers using a set of physics-based equations and the simulation data for a set of selected simulation parameters;
create a training dataset using the simulation data and the auxiliary quantities; and
train a machine learning model using the training dataset to select a number of the aquifers that meet a set of carbon storage requirements to store carbon dioxide.
